(19) United States
(12) Patent Application Publication
(10) Pub. No.: US 2015/0134310 A1
(43) Pub. Date: May 14, 2015

(54) Method for Simulating a Set of Elements, and Associated Computer Program

(71) Applicant: Inria Institut National de Recherche en Informatique et en Automatique, Le Chesnay (FR)

(72) Inventors: Svetlana Artemova, Grenoble (FR); Stéphane Redon, Grenoble (FR)

(21) Appl. No.: 14/402,116

(22) PCT Filed: May 23, 2013
(86) PCT No.: PCT/EP2013/060622

§ 371 Date: Nov. 19, 2014

(30) Foreign Application Priority Data
May 25, 2012 (FR) 12 54838

(51) Int. Cl. G06F 17/50

(52) U.S. Cl. CPC G06F 17/5009
USPC 703/2

(57) ABSTRACT

Method for simulating a system of elements, according to which the behaviour of said elements is determined on the basis of a Hamiltonian H of the system of elements, such as (formula I) where p is a vector indicating the moments of the elements. q is a vector indicating the positions of the elements, M⁻¹ being a diagonal matrix that is a function of the masses of the elements, and V being the potential energy of the system, the method comprising a step according to which, when the vector moment p assumes certain predetermined values relating to at least one element, a value of zero is allocated to at least one diagonal term of the matrix M⁻¹ relating to said element.

The present invention relates to a method for simulating a set of elements, according to which the behaviour of the elements is determined on the basis of a Hamiltonian associated with the system of elements (the sum of the kinetic energy and the potential energy of the set)

$$H ( p , q ) = \frac{1}{2} {p}^{T} \cdot {M}^{- 1} \cdot p + V ,$$

p being a vector indicating the moments of the elements, V being the potential energy of the system, and M⁻¹ being a diagonal matrix that is a function of the masses of the elements (in some cases, this matrix can be a function of the positions of the elements).

The potential energy in some cases is, for example, equal to [or is a function of] the interaction potential V(q) between the elements whose interaction forces can be derived, q being a vector indicating the positions of the elements (in a more general case, the interaction potential can also be dependent on the moments of the elements).

Simulation of a set of elements allows the behaviour of such a set to be studied and its properties to be analysed: the displacements in terms of successive positions and the moments of the elements, the correlations of the displacements between elements, the changes of structure, the increases and decreases of interactions between elements, the configurations adopted on average, the evolutions of the associated energies, etc. The elements can represent mechanical bodies, for example celestial bodies or fluids, particles such as atoms or molecules, for example proteins, fluids, etc.

A conventional manner of simulating a set of elements is to consider the Hamiltonian of the set and to derive equations of motion therefrom.

WO 2009/007550 describes, for example, a technique of simulating a set of elements.

The evolutions of the set of elements must sometimes be simulated over a long period in order to be able to observe certain phenomena or to be able to calculate certain statistics. The calculation times, and the cost in terms of calculation, of such simulations then sometimes become considerable. Methods have been proposed for accelerating the simulations of a set of elements.

The present invention aims to propose a novel solution for reducing these problems.

To that end, according to a first aspect, the invention proposes a method for simulating a set of elements of the type mentioned above, which method is carried out by a computer and is characterized in that said method comprises a step according to which, when the moment vector p assumes certain predetermined values relating to at least one element, a value of zero is allocated to at least one diagonal term of the matrix M⁻¹ relating to said element.

The invention makes it possible to reduce the calculation volume, and consequently the calculation time, required for determining the potential energy, the interaction potential, interaction forces, positions and/or moments of the elements.

In embodiments, the method for simulating a set of elements according to the invention further comprises one or more of the following features:
said method comprises a step according to which, for at least one of said elements, if a parameter representing the kinetic energy of said element has a value below a first strictly positive threshold, a value of zero is allocated to at least one diagonal term of the matrix M⁻¹ relating to said element;
the diagonal terms of the matrix M⁻¹ which are a function of the mass of an element are allocated a maximum value when the kinetic energy of said element is greater than a second strictly positive threshold;
a value of zero is allocated to at least one diagonal term of the matrix M⁻¹ relating to said element if the couple comprising the moment of the element and the position of the element assumes certain predetermined values;
it comprises a step of determining values of at least one piece of information at successive simulation time instants on the basis of said Hamiltonian, said step utilizing the fact that the values of the information relating to a k-uplet of elements, where k is an integer greater than or equal to 2, for which a value of zero has been allocated to the diagonal terms of the matrix M⁻¹ at a preceding simulation time instant are consequently unchanged between at least said preceding simulation time instant and the current simulation time instant, and calculating a value of the information relating to a given element, at a current simulation time instant, by carrying out the following steps when values of zero have not been allocated to the diagonal terms of the matrix concerning each element of a k-uplet of elements of which said given element forms part:
   calculate a working value of said information relating to said given element by subtracting from the value of the information relating to said given element and determined at the preceding simulation time instant at least the values of the information relating to said given element and associated with said k-uplets of elements at the preceding simulation time instant, and/or
   add to said working value at least the values of the information relating to said given element and associated with the k-uplets of elements, determined at the current simulation time instant;
at a current calculation time instant, a current list of the pairs of elements that are separated by a distance below a given threshold is prepared at a current simulation time instant and is compared with a preceding list of pairs of elements that are separated by a distance below a given threshold prepared at a preceding simulation time instant,
and the value of a piece of information relating to a given element, at a current simulation time instant, is calculated on the basis of the pairs comprising said given element by carrying out the following steps:
   calculate a working value by subtracting from the value of information relating to said given element and determined at the preceding simulation time instant the values of information relating to said given element associated with the other element of the pairs under consideration if the pair under consideration is present only in the preceding list or if the vector linking said given element to the other element of the pair has varied between the preceding simulation time instant and the current simulation time instant;
   the value of the information relating to said given element at a current simulation time instant is determined by adding to the working value the values of the information relating to said given element and associated with the other element of the pairs under consideration if the pair under consideration is present only in the current list or if the vector linking said element to the other element of the pair has varied between the preceding simulation time instant and the current simulation time instant;
at a current calculation time instant, a current list of k-uplets of elements that satisfy certain conditions, where k is an integer greater than or equal to two, is prepared at a current simulation time instant and is compared with a preceding list of k-uplets of elements that satisfy said conditions at a preceding simulation time instant,
and the value of a piece of information relating to an element at a current simulation time instant is calculated on the basis of the k-uplets comprising said element by carrying out the following steps:
   calculate a temporary value by subtracting from the value of the information relating to said element and determined at the preceding simulation time instant the values of the information relating to said element and associated with said k-uplets at the preceding simulation time instant, when said k-uplets are present only in the preceding list or when the values of the information relating to said element and associated with said k-uplets have changed between the preceding simulation time instant and the current simulation time instant;
   determine the value of the information relating to said element at the current simulation time instant by adding to the temporary value the values of the information relating to said element and associated with said k-uplets at the current simulation time instant, when said k-uplets are present only in the current list or when the information associated with said k-uplets has changed between the preceding simulation time instant and the current simulation time instant (for example when relative positions of the k elements in the k-uplet have changed);
the localization space of the elements is partitioned into cells and each element, at each preceding simulation time instant and a current simulation time instant, is associated with a belonging cell according to position coordinates determined at said simulation time instant, and according to which, for the first elements such that the terms of the matrix M⁻¹ relating to said first elements have not been allocated a value of zero at a current simulation time instant, the following steps are carried out:
   the belonging cell of the first elements at the preceding simulation time instant is determined;
   for each first element, there are determined in said belonging cell or its cells in a given vicinity of the belonging cell, the second elements that are situated at the preceding simulation time instant at a distance below a given threshold from said first element; a working value is calculated by subtracting from the value of a piece of information relating to said first element and determined at the preceding simulation time instant the values of said information relating to said first element and associated with said second elements;
   the new belonging cell of the first elements at the current simulation time instant is determined;
   for each first element, there are determined in the new belonging cell or the cells in the given vicinity of the new belonging cell, the third elements that are situated at the current simulation time instant at a distance below a given threshold from said first element;
   the value of the information relating to said first element, at the current simulation time instant, is determined by adding to the working value the values of the information relating to the first element and associated with the third elements;
the information relating to said element includes the potential energy of said element and/or the interaction force applied to said element;
it comprises, at certain simulation time instants, a step of determining a piece of information I, said step advantageously utilizing the fact that a value of zero has been allocated to certain diagonal terms of the matrix M⁻¹ at certain simulation time instants;
it comprises, at certain simulation time instants, a step of determining a piece of information I, said step advantageously utilizing the fact that this piece of information I is unchanged and does not have to be determined again when it has been determined at a previous simulation time instant and a value of zero has been allocated to a corresponding set of diagonal terms of the matrix M⁻¹ between at least said previous simulation time instant and the current simulation time instant (“corresponding set of diagonal terms” is understood as meaning the diagonal terms which have an influence on the value of the piece of information I, that is to say the piece of information I does not change when those terms are zero);
it comprises, at certain simulation time instants, a step of determining the potential energy, or the interaction forces, said step advantageously utilizing the fact that a value of zero has been allocated to at least one diagonal element of the matrix M⁻¹ at certain simulation time instants.

According to a second aspect, the present invention proposes a computer program for simulating a system of elements, comprising software instructions for carrying out the steps of a method according to any one of claims 1 to 12 during execution of the program by computing means. These features and advantages of the invention will become apparent upon reading the following description, which is given solely by way of example and with reference to the accompanying drawings, in which:

FIG. 1 shows a device implementing an embodiment of the invention;

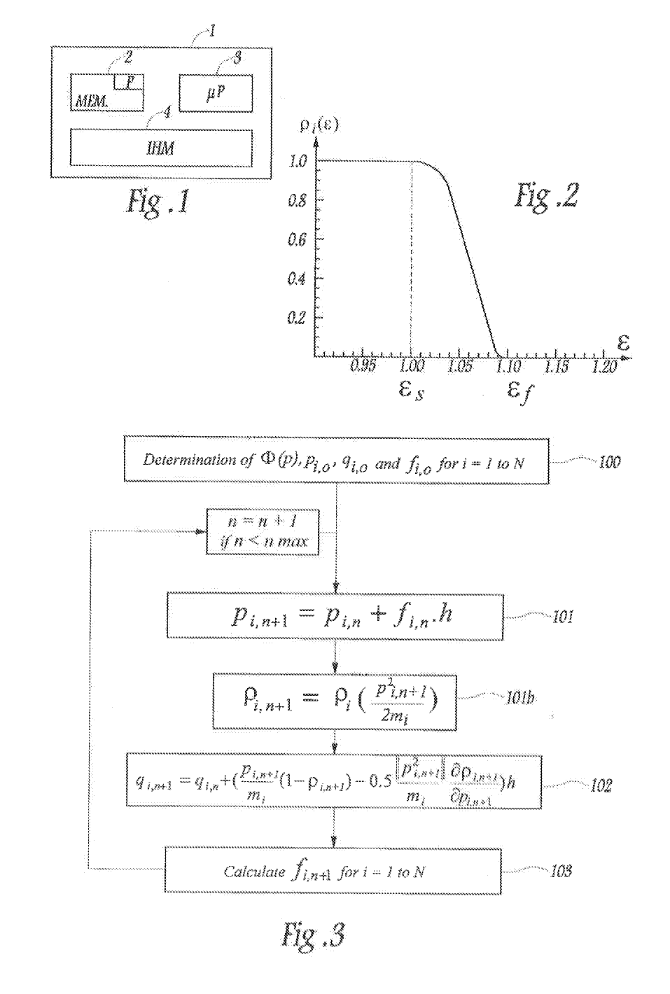

FIG. 2 shows on the y-axis the evolution of the function ρᵢ(εᵢ) as a function of εᵢ shown on the x-axis;

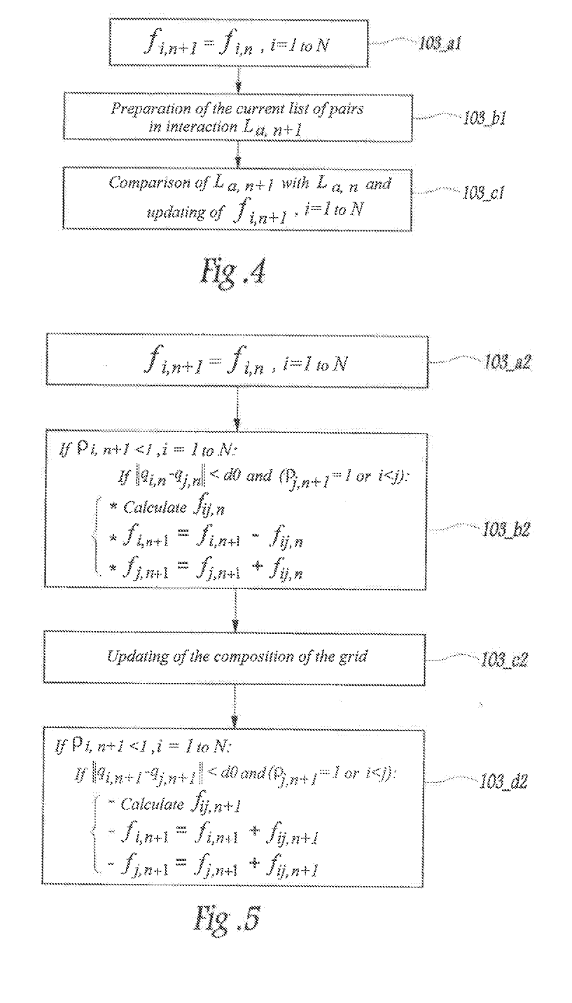

FIG. 3 is flow chart of the steps of a method in an embodiment of the invention;

FIG. 4 shows an embodiment of step 103;

FIG. 5 shows another embodiment of step 103;

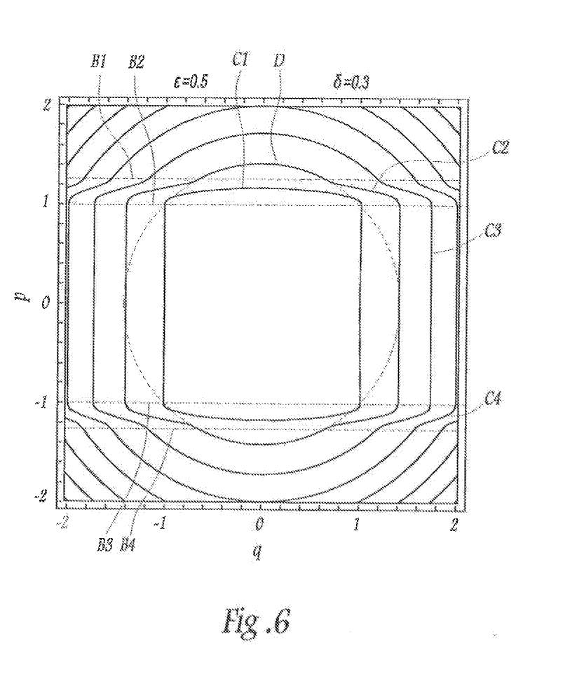

FIG. 6 shows simulations of the trajectory of a particle associated with a fixed point, in the phase space (p,q), with constant Hamiltonian.

Let us consider the simulation of a set E of N particles aᵢ, i=1 to N.

The Hamiltonian H(p,q) associated with the set E (see, for example, “Understanding molecular simulation: from algorithms to applications”, Frenkel D., Smit B.) is often written as follows:

$$H ( p , q ) = \frac{1}{2} {p}^{T} \cdot {M}^{- 1} \cdot p + V ( q ) ,$$

p being a vector indicating the moment of the particles, q a vector indicating the position of the particles, M⁻¹ a diagonal matrix that is a function of the masses of the particles.

V(q) is the interaction potential between the N particles; it is a function of their position and will be considered to be independent of the moments.

In a space in 3 dimensions, for example, with a reference frame of coordinates (X, Y, Z), the moment pᵢ of each particle aᵢ, i=1 to N, is written (p_{i,x}, p_{i,y}, p_{i,z}) and the position qᵢ of each particle aᵢ, i=1 to N, is written (q_{i,x}, q_{i,y}, q_{i,z}).

The vectors p and q are therefore written:

$$p = [ \begin{matrix}{p}_{1 , x} \\ {p}_{1 , y} \\ {p}_{1 , z} \\ ⋮ \\ {p}_{N , x} \\ {p}_{N , y} \\ {p}_{N , z}\end{matrix} ] and q = [ \begin{matrix}{q}_{1 , x} \\ {q}_{1 , y} \\ {q}_{1 , z} \\ ⋮ \\ {q}_{N , x} \\ {q}_{N , y} \\ {q}_{N , z}\end{matrix} ] .$$

Usually, the matrix M⁻¹ used in the prior art is a diagonal matrix of dimension 3N*3N, of which the terms M[3i-2, 3i-2]=M[3i-1, 3i-1]=M[3i, 3i]=mᵢ, for i=1 to N, where mᵢ is the mass of the particle aᵢ.

That is the usual definition of the Hamiltonian H, which will be called the standard Hamiltonian below.

According to the invention, a Hamiltonian called the adaptive Hamiltonian H_{A} is defined, here below:

$${H}_{A} ( p , q ) = \frac{1}{2} {p}^{T} \cdot Φ ( p , q ) \cdot p + V ( q ) ,$$

wherein Φ(p,q), a 3N*3N diagonal matrix called an adaptive inverse mass matrix, replaces M⁻¹ and depends on the vector p and optionally the vector q.

From this adaptive Hamiltonian H_{A} there are derived adaptive equations of motion defining \dot{p} and \dot{q}, which are the derivatives of the vectors p and q relative to time t.

For example, in the implementation of a simulation in an NVE ensemble (set E with a constant number of particles, volume and energy), which is first considered here by way of illustration, the value of the Hamiltonian (adaptive according to the invention or standard) is constant over time, and the adaptive equations of motion are:

$$\dot{p} = \frac{\partial p}{\partial t} = - \frac{\partial {H}_{A}}{\partial q} = - \frac{\partial V}{\partial q} - \frac{1}{2} {p}^{T} \frac{\partial Φ ( p , q )}{\partial q} p , \\ \dot{q} = \frac{\partial q}{\partial t} = \frac{\partial {H}_{A}}{\partial p} = Φ ( q , p ) p + \frac{1}{2} {p}^{T} \frac{\partial Φ ( p , q )}{\partial p} p . \qquad formulae ( 1 )$$

According to the invention, the terms of the matrix Φ relating to the particle aᵢ, for i=1 to N, are as follows:

$$Φ [ 3 i - 2 , 3 i - 2 ] ( {p}_{i} , {q}_{i} ) = Φ [ 3 i - 1 , 3 i - 1 ] ( {p}_{i} , {q}_{i} ) = Φ [ 3 i , 3 i ] ( {p}_{i} , {q}_{i} ) = \frac{1}{{m}_{i}} ( 1 - {ρ}_{i} ( {p}_{i} , {q}_{i} ) ) ,$$

where mᵢ is the mass of the particle aᵢ.

The value

$$\frac{1}{{m}_{i}} ( 1 - {ρ}_{i} ( {q}_{i} , {p}_{i} ) )$$

is named Φᵢ (pᵢ,qᵢ).

According to the invention, ρᵢ(qᵢ,pᵢ)ε[0,1] and is a twice differentiable function, which is used so that the position of the particle is constant over a certain time.

When ρᵢ(qᵢ,pᵢ)=0 (that is to say the position of the particle a, is not fixed),

$${Φ}_{i} ( {p}_{i} , {q}_{i} ) = \frac{1}{{m}_{i}}$$

and the particle aᵢ follows the usual dynamic laws corresponding to the standard Hamiltonian H of the system E.

When ρᵢ(qᵢ,pᵢ)=1 (that is to say the position of the particle is fixed), Φᵢ (pᵢ,qᵢ)=0 and the particle aᵢ does not move, whatever the forces which act thereon (its mass is considered to be infinite).

When ρᵢ(qᵢ,pᵢ)ε]0,1[, the particle aᵢ carries out a smooth transition between those two behaviours.

The twice differentiable nature of p, allows the stability of the set E of particles to be preserved.

In one embodiment of the invention, it is defined that:

$${ρ}_{i} ( {q}_{i} , {p}_{i} ) = {ρ}_{i} ( {ɛ}_{i} ) = \{ \begin{matrix}1 if 0 \leq {ɛ}_{i} \leq {ɛ}_{i}^{r} \\ 0 if {ɛ}_{i} \geq {ɛ}_{i}^{f} \\ {s}_{i} ( {ɛ}_{i} ) ∈ [ 0 , 1 ] if {ɛ}_{i} ∈ [ {ɛ}_{i}^{r} , {ɛ}_{i}^{f} ]\end{matrix}$$

where s(εᵢ) is a function of pᵢ and optionally of qᵢ, and is twice differentiable.

In FIG. 2, the values assumed by ρᵢ(εᵢ) in one embodiment are shown on the y-axis, as a function of the values assumed by εᵢ, which is shown on the x-axis, where εᵢ^{r}=1 and εᵢ^{f}=1.1.

For example, a possible form for sᵢ(εᵢ) is −6χ⁵+15χ⁴−10χ³+1, where

$$η = \frac{{ɛ}_{i} - {ɛ}_{i}^{r}}{δ}$$

and δ=εᵢ^{f}−εᵢ^{r}.

In the embodiment considered hereinbelow, the function εᵢ, which relates to the particle aᵢ, is chosen to be equal to the kinetic energy of the particle aᵢ, namely

$${ɛ}_{i} = \frac{{p}_{i}^{2}}{2 {m}_{i}} .$$

The invention therefore consists in “fixing” the particles by allocating thereto an infinite “pseudo”-mass when their kinetic energy falls below a certain value, the quantity of motion of the particles not being fixed.

The function ρᵢ is a function which includes the moment as the variable (in the particular case considered by way of example, it is therefore not dependent on the position qᵢ: ρᵢ(qᵢ,pᵢ)=ρᵢ(pᵢ)).

In other embodiments, the function ρᵢ can be a function that is dependent on the moment of the particle aᵢ (and optionally its position) other than the kinetic energy of course.

In some embodiments, a particle of which the moment (or the couple comprising the moment and the position) assumes predetermined values (discrete values or ranges of values) is fixed.

The adaptive equations of motion (1) thus become:

$$\dot{p} = - \frac{\partial {H}_{A}}{\partial q} = - \frac{\partial V}{\partial q} , \\ \dot{q} = \frac{\partial {H}_{A}}{\partial p} = {M}^{- 1} ( 1 - ρ ( p ) ) p - \frac{1}{2} {p}^{T} {M}^{- 1} \frac{\partial ρ ( p )}{\partial p} p , \qquad formulae ( 2 )$$

where ρ(p) is a 3N*3N diagonal matrix indicating the ρᵢ(qᵢ,pᵢ), for i=1 to N: ρ(p) [3i-2,3i-2]=ρ(p) [3i-1,3i-1]=ρ(p) [3i,3i]=ρᵢ(qᵢ,pᵢ), for i=1 to N.

As indicated above, when ρᵢ(qᵢ,pᵢ)=0 (that is to say the position is not fixed),

$${Φ}_{i} ( {p}_{i} , {q}_{i} ) = \frac{1}{{m}_{i}}$$

and the particle aᵢ follows the usual dynamic laws corresponding to the standard Hamiltonian H of the system E.

When ρᵢ(qᵢ,pᵢ)=1 (that is to say the position of the constant particle is fixed), Φᵢ(pᵢ,qᵢ)=0, consequently, \dot{q} has a value of zero (in fact, ρᵢ then being constant equal to 1, the value of the term

$$\frac{\partial {p}_{i} ( {p}_{i} )}{\partial {p}_{i}}$$

is zero). In one interpretation, the mass is considered to be infinite, the particle aᵢ is considered to be fixed.

When ρᵢ(qᵢ,pᵢ)ε]0,1[, the particle aᵢ carries out a smooth transition between those two behaviours.

Thus, according to the invention, the matrix Φ(p,q) specifies how, and when, degrees of freedom in terms of position of one or more particles are activated or deactivated during the simulation.

To give an example which explains the behaviour of the system in the case of the invention, FIG. 6 shows trajectory simulations in one dimension in the phase space (p,q), of a system comprising a particle of mass 1, attached to a spring of stiffness 1 at a fixed point. In this case, N=1. The isolines of the adaptive Hamiltonian are represented, for ε₁^{r}=0.5 and ε₁^{f}=0.8.

Especially curves C1, C2, C3, C4 each correspond to a respective constant value of the adaptive Hamiltonian. For example, curve C1 corresponding to a Hamiltonian equal to 1. The circle D corresponding to a constant value equal to I of a standard, that is to say non-adaptive, Hamiltonian.

The zone of the phase space where the particle is fixed is located between the dashed lines B2 and B3 (it corresponds to a moment value included in [˜1, 1]).

The zone of the phase space where the particle is free and follows a trajectory according to a standard Hamiltonian is found above line B1 and below line B4.

The zone of the phase space between lines B1 and B2 and between the dashed lines B3 and B4 corresponds to a transition zone between the free and fixed states of the particle.

On each isoline C1, C2, C3, C4, in the zone where the particle is fixed, the position q does not change, but the moment p changes.

In order to carry out a simulation of the system E, a numerical integration over time of these equations of motion indicated in formulae (2) is to be performed. In the case of the implementation of a simulation in an NVE ensemble considered here by way of illustration, a partitioned Euler method is used, for example (see, for example, “Geometric numerical integration: structure preserving algorithms for ordinary differential equations”, Hairer E., Lubich C., Wanner G.; Volume 31; Springer Verlag 2006) for this numerical integration.

According to this Euler method, equations of the form:

\dot{u}=a(u,v),

\dot{v}=b(u,v),

result, for the numerical integration, in the following set of equations wherein h is a time step:

uₙ₊₁=uₙ+a(uₙ₊₁,vₙ)h,

vₙ₊₁=vₙ+b(uₙ₊₁,vₙ)h.

Thus, according to this method, the formulae (2) can be written as follows:

$${p}_{n + 1} = {p}_{n} - \frac{\partial V ( {q}_{n} )}{\partial {q}_{n}} h , \\ {q}_{n + 1} = {q}_{n} + ( {M}^{- 1} ( 1 - ρ ( {p}_{n + 1} ) ) {p}_{n + 1} - \frac{1}{2} {p}_{n + 1}^{T} {M}^{- 1} \frac{\partial p ( {p}_{n + 1} )}{\partial {p}_{n + 1}} {p}_{n + 1} ) h . \qquad Formulae ( 3 )$$

In one embodiment of the invention, a computer device 1 shown in FIG. 1 is used to carry out a simulation of a set E of N particles.

The device 1 comprises a computer having notably a memory 2 adapted for storing software programs and successively calculated parameter values described below (values of the coefficients of the matrix Φ, total, partial interaction forces, interaction potential, positions, moments, etc.), a microprocessor 3 adapted for executing the instructions of software programs and especially of the program P described below, and a man/machine interface 4 comprising, for example, a keyboard and a screen for typing the instructions of a user and for displaying information intended for the user, for example curves such as those shown in FIG. 6.

In the embodiment of the invention under consideration, the memory 2 includes the program P simulating the behaviour of the set E of particles of type NVE.

The program P includes software instructions which, when they are executed on the microprocessor 3, are adapted to perform the following steps, with reference to FIG. 3.

In a previous step 100, the functions ρ₁(pᵢ,qᵢ) of the matrix Φ are defined beforehand for each particle aᵢ.

In the present case, the functions defined above

$${ρ}_{i} ( \frac{{p}_{i}^{2}}{2 {m}_{i}} )$$

have been chosen and thus define Φ(p) as a function of the vector of the moments p, and of the fixed values for εᵢ^{r} and εᵢ^{f}.

Initial values are also determined for the moment p_{i,0}, the position q_{i,0} and the interaction force f_{i,0} of each particle aᵢ, i=1 to N, corresponding to an initial time instant h₀.

The following steps are then carried out iteratively in a n+1^{th} iteration of the program P corresponding to the calculation time instant hₙ₊₁=h₀+(n+1)h, where n is an integer ≧0, h being the simulation time step.

Hereinbelow:

f_{ij,n+1} will denote the interaction force exerted by the particle aⱼ on the particle aᵢ (which is equal to −f_{ji,n+1}) in the calculation step hₙ₊₁;

f_{i,n+1} will denote the total interaction force acting on the particle aᵢ, i=1 to N, which is due to the interactions exerted by all the other particles of the system E, considered at the calculation time instant hₙ₊₁; it is therefore equal to

$${\sum }_{j = 1}^{N} {f}_{ij , n + 1} ;$$

p_{i,n+1} will denote the value of the moment of the particle aᵢ at the calculation time instant hₙ₊₁;
q_{i,n+1} will denote the value of the position of the particle a, at the calculation time instant hₙ₊₁;

ρ_{i,n+1} will denote the value assumed by the function ρᵢ at the calculation time instant hₙ₊₁ (as seen above; it is a function of the value of the kinetic energy

$$\frac{{p}_{i , n + 1}^{2}}{2 {m}_{i}} ) .$$

Steps 101, 101b, 102, 103 are intended to determine updated values of the moment, the position and the total interaction force, respectively, relating to each of the particles aᵢ.

In a step 101, the current value p_{i,n+1} of the moment of each particle aᵢ, i=1 to N, is determined according to formulae (3), the value of the total interaction force f_{i,n} exerted on the particle aᵢ determined at the preceding calculation time instant having been stored in the memory 2 as that of the moment p_{i,n}

p_{i,n+1}=p_{i,n}+f_{i,n}h.

In a step 101b, the value ρ_{i,n+1} is recalculated from the new value of the moment p_{i,n+1}:

$${ρ}_{i , n + 1} = {ρ}_{i} ( \frac{{p}_{i , n + 1}^{2}}{2 {m}_{i}} ) .$$

In a step 102, the current value q_{i,n+1} of the position of each particle aᵢ, i=1 to N, is now determined according to formulae (3):

$${q}_{i , n + 1} = {q}_{i , n} + ( \frac{{p}_{i , n + 1}}{{m}_{i}} ( 1 - {ρ}_{i , n + 1} ) - 0.5 \frac{‖ {p}_{i , n + 1}^{2} ‖}{{m}_{i}} \frac{\partial {ρ}_{i , n + 1}}{\partial {p}_{i , n + 1}} ) h .$$

In a step 103, the current value f_{i,n+1} of the total interaction force acting on the particle aᵢ, and which is due to all the other particles at least, i=1 to N, is determined according, for example, to one of the two methods indicated hereinbelow.

The result of this numerical integration is the updated value of the positions qᵢ and of the moments pᵢ of each particle aᵢ, where i=1 to N, determined for the calculation time instant hₙ₊₁.

The updated value of other characteristic parameters of the behaviour of the particles aᵢ at time instant hₙ₊₁ can further be calculated, for example the current value of the potential energy of the system E, the value of the autocorrelation between the particle speeds.

Then, if the maximum duration of the simulation has not been reached, that is to say if n+1≦nₘₐₓ, a further iteration of the program P is carried out.

Various techniques for calculating the updated values of the interaction forces in step 103, which advantageously permit utilization of the definition of the matrix Φ, can be used.

A first technique comprises the following steps.

In the initialization step 100, a current list of the pairs of particles is prepared, such that the distance between the particles of each pair at initialization is below a threshold d0 (when the distance between two particles is greater than d0, the interaction between those two particles is disregarded), and the interaction force f_{ij,0} of the particle aⱼ on the particle aᵢ of each pair present in the current list is further evaluated as a function of the distance separating them and according to the simulated force field, and stored.

With each pair in the list there is associated an element e_{ij,0}, which is also stored in the memory 2, comprising the identifier of each of the two particles aᵢ, aⱼ of the pair, the coordinates of the vector r₀^{i,j} joining the two particles and starting from particle aᵢ, and the interaction force f_{ij,0} exerted by the particle aⱼ on the particle as (which is equal to −f_{ji,0}, f_{ji,0} being the interaction force exerted by the particle aᵢ on the particle aⱼ).

The total interaction force f_{i,0} acting on the particle aᵢ is equal to the sum of the interaction forces f_{ij,0} exerted on the particle aᵢ by the particles aⱼ, j=1 to N.

In each iteration of step 103, the steps below are then carried out, with reference to FIG. 4.

Let the current iteration be the (n+1)^{th}.

In a step 103_a1, there is allocated as the starting value to the total interaction force f_{i,n+1} acting on each particle aᵢ the value of the total interaction force f_{i,n} calculated in the preceding iteration.

In a step 103_b1, a current list L_{a,n+1} of the pairs of particles in interaction is prepared, that is to say these are the pairs of particles such that the distance between the particles of each pair under consideration at the calculation time instant hₙ₊₁ is below the threshold d0.

With each pair in the list L_{a,n+1} there is associated an element e_{ij,n+1} comprising the identifier of each of the two particles aᵢ, aⱼ of the pair, the coordinates of the vector rₙ₊₁^{i,j} joining the two particles from particle aᵢ, in accordance with their localization at time instant hₙ₊₁, and the interaction force f_{ij,n+1} exerted by the particle aⱼ on the particle aᵢ (which is equal to −f_{ji,n+1}, f_{ji,n+1} being the interaction force exerted by the particle aᵢ on the particle aⱼ), the value of which at this stage is not known.

Then, in a step 103_c1, the current list of pairs L_{a,n+1} is compared with the preceding list L_{a,n} of pairs, that is to say the list established in the preceding iteration (namely the n^{th} iteration). With each pair in the list L_{a,n} there is associated an element e_{ij,n} comprising the identifier of each of the two particles aᵢ, aⱼ of the pair, the coordinates of the vector rₙ^{i,j} joining the two particles and starting from the particle aᵢ, calculated as a function of the positions determined in the preceding iteration for the particles aᵢ, aⱼ, and the value of the interaction force f_{ij,n} exerted by the particle aⱼ on the particle aᵢ (which is equal to −f_{ji,n}, f_{ji,n} being the interaction force exerted by the particle a, on the particle aⱼ).

If a pair is present only in the preceding list L_{a,n}, this means that the interaction between the two particles of the pair has disappeared between iteration n and iteration n+1.

For each pair aᵢ, aⱼ present only in the preceding list, there is taken away from the total interaction force currently being determined f_{i,n+1} acting on the particle aᵢ, or f_{j,n+1} acting on the particle aⱼ, the interaction force f_{ij,n} calculated in step 100 in the preceding iteration, or the interaction force f_{ji,n}=−f_{ij,n}.

If a pair is present only in the current list L_{a,n+1}, this means that the interaction between the two particles of the pair has appeared between iteration n and iteration n+1.

For each pair aᵢ, aⱼ present only in the current list, there is then calculated the interaction force f_{ij,n+1} exerted by the particle aⱼ on the particle aᵢ, as a function of their respective positions especially; it is saved in the memory in the element e_{ij,n+1}. The interaction force f_{ij,n+1} is added to the total interaction force on the particle aᵢ currently being determined f_{i,n+1}, and the interaction force f_{ji,n+1}=−f_{ij,n+1} is added to the total interaction force currently being determined f_{j,n+1} acting on the particle aⱼ.

If a pair is included in both the current list L_{a,n+1} and the preceding list Lₐₙ, the vectors rₙ^{i,j} and rₙ₊₁^{i,j} joining the two particles aᵢ, aⱼ are compared. If they are different, the interaction force f_{ij,n+1} exerted by the particle aⱼ on the particle aᵢ is calculated, as a function of their respective positions especially, and that interaction force f_{ij,n+1} is saved in the element e_{ij,n+1}. The interaction force f_{ij,n+1} is added to the total interaction force currently being determined f_{i,n+1} acting on the particle aᵢ. The interaction force f_{ji,n+1}=−f_{ij,n+1} is added to f_{j,n+1} acting on the particle aⱼ. Furthermore, the interaction force f_{ij,n} calculated in step 100 in the preceding iteration, or the interaction force f_{ji,n}=−f_{ij,n}, is taken away from the total interaction force currently being determined f_{i,n+1} acting on the particle aᵢ, or f_{j,n+1} acting on the particle aⱼ.

By fixing the positions of particles, the invention generates an increased number of pairs for which the vector between two particles, and therefore the interaction force between those two particles, remains unchanged.

In such a case, the methods proposed for step 103 mean that, by utilizing the features of a method according to the invention, it is not necessary to recalculate all the components of the total interaction forces.

This technique of determining the values of the total interaction forces is optimum in terms of calculation volume. However, the preparation of the lists requires time.

A second technique for carrying out step 103 allows the advantages provided by the invention to be utilized without using a comparison of the lists of pairs of particles in interaction in the current iteration relative to the preceding iteration, but using a three-dimensional grid (if the motion of the particles is considered in a three-dimensional space; if the particles move in a plane, a two-dimensional grid may be sufficient).

In the initialization step 100, in addition, an initial grid is created, considering a parallelepiped containing all the particles and subdividing it into cells, for example cubic cells, the size of one side of which is greater than or equal to d0.

Each particle aᵢ, i=1 to N, is then allocated to the cell to which it belongs, according to the position of the particle at the initialization step.

Then, for each particle a, which is located in a given cell, the given cell and/or the cells which are adjacent thereto (a maximum of 26 cells being considered) in which particles aⱼ are at a distance from the particle aᵢ of less than d0 are considered. For those particles aⱼ situated at a distance from the particle aᵢ below d0 and such that j>i, the interaction force f_{ij,0} of the particle aⱼ on the particle aᵢ is calculated. This force is equal to −f_{ji,0}, f_{ji,0} being the interaction force exerted by the particle aᵢ on the particle aⱼ.

It will be noted that in the embodiment described, the adjacent cells under consideration are the cells that are immediately adjacent, that is to say which have at least one side in common with the given cell; in other embodiments, the adjacent cells under consideration are those situated at r cells distance from a cell immediately adjacent to the given cell.

The following steps are then carried out in each iteration n+1 of the program P, where n≧0, with reference to FIG. 5.

In a step 103_a2, the value of the total interaction force calculated in the preceding iteration f_{i,n} is allocated as the starting value to the overall interaction force f_{i,n+1} acting on each particle aᵢ.

In a step 103_b2, for all the particles aᵢ for which ρ_{i,n+1}<1 (that is to say the particles that are not considered to be fixed), the particles aⱼ that verify the following conditions are determined:
in the preceding iteration (n), these particles aⱼ were situated in the cell in which the particle aᵢ was positioned in the preceding iteration n, or the cells which are adjacent thereto (a maximum of 26 cells being considered); and
in the preceding iteration n, these particles aⱼ were at a distance from the particle a, of below d0; and
these particles aⱼ verify that their index j is strictly greater than i or verify that ρ_{j,n+1}=1.

The composition of the grid considered hitherto is therefore that which corresponds to the positions updated in the preceding iteration (iteration n).

Then, for each of these particles aⱼ so determined, the interaction force f_{ij,n} exerted by the particle aⱼ on the particle aᵢ (and thus the interaction force f_{ij,n} exerted by the particle aᵢ on the particle aⱼ) is calculated as a function of the distance separating them in the preceding step n.

And this interaction force f_{ij,n} exerted by the particle aⱼ on the particle aᵢ is subtracted from the total interaction force exerted on aᵢ; likewise, the interaction force f_{ji,n} exerted by the particle aᵢ on the particle aⱼ is subtracted from the total interaction force exerted on aⱼ: there are thus calculated f_{i,n+1}=f_{i,n+1}−f_{ij,n} and f_{j,n+1}=f_{j,n+1}−f_{ji,n}=f_{j,n+1}+f_{ij,n}.

In a step 103_c2, the composition of the grid is updated by determining the current belonging cells of all the particles aᵢ for which ρ_{i,n+1}<1 (that is to say the particles that are not considered to be fixed), according to the positions q_{i,n+1} of those particles corresponding to iteration n+1.

In a step 103_d2, for all the particles a, for which ρ_{i,n+1}<1 (that is to say the particles that are not considered to be fixed), the particles aⱼ that verify the following conditions are determined:
in the current iteration (n+1), these particles aⱼ are situated in the cell in which the particle a, is positioned in the current iteration, or the cells which are adjacent thereto (a maximum of 26 cells being considered); and
in the current iteration (n+1), these particles aⱼ are at a distance from the particle aᵢ below d0; and
these particles aⱼ verify that their index j is strictly greater than i or verify that ρ_{j,n+1}=1.

The composition of the grid under consideration here is therefore that corresponding to the positions updated in the current iteration (iteration n+1).

Then, for each of the particles aⱼ so determined, the interaction force f_{ij,n+1} exerted by the particle aⱼ on the particle aᵢ (and thus the interaction force f_{ji,n+1} exerted by the particle aᵢ on the particle aⱼ) is calculated as a function of the distance separating them in the current step n+1.

And this interaction force f_{ij,n+1} exerted by the particle aⱼ on the particle aᵢ is added to the total interaction force exerted on aᵢ; likewise, the interaction force f_{ji,n+1} exerted by the particle aᵢ on the particle aⱼ is added to the total interaction force exerted on aⱼ: there are thus calculated f_{i,n+1}=f_{i,n+1}+f_{ij,n+1} and f_{j,n+1}+f_{ji,n+1}=f_{j,n+1}−f_{ij,n+1}.

Like the first technique, this second technique utilizes the fact that some of the particles have been fixed by not recalculating the interaction forces between fixed particles. It effects the subtraction of the forces corresponding to the previous positions and the addition of those corresponding to the new positions. It does not include the lengthy operation of preparing lists and carrying out comparisons between the pairs of each list. By contrast, the volume of the interaction forces between two particles that is to be calculated is greater than that to be carried out in the first technique.

It will additionally be noted that, in the examples above, interaction forces have been considered between the particles under consideration two by two in order to calculate the interaction potentials and update those potentials. Nevertheless, the invention also enables the corresponding burden of calculation to be reduced when the calculation of the potential involves interaction forces between k particles, k being strictly greater than 2. In this case, the current interaction potential is calculated from the interaction potential determined in the preceding simulation step by advantageously utilizing the fact that the interaction force between k particles is unchanged between the current simulation step and the preceding step (and consequently does not have to be recalculated) when the k particles are fixed particles. There are then subtracted from the total forces exerted on the particles the forces calculated in the preceding step which relate to the k_uplets of particles comprising particles which have moved between the preceding simulation step and the current step. There are calculated and added to the total forces exerted on the particles so obtained the current forces relating to the k_uplets of particles comprising particles which have moved, as a function of their new positions.

For k=2, or where k is other than 2, similar operations can be carried out in order to update the potential energy of the system, the potential energy being considered to be the sum of the potential energies between not more than k particles. Similar operations can also be carried out in order to update values or structures of data which depend on the positions of not more than k particles where k is any integer greater than or equal to 1.

For example, in a simulation relating to a set of 5 particles or more, the information to be calculated includes the centre of gravity of the 5 particles considered, which changes over time but is only to be determined every 10 simulation time steps. If the terms of the adaptive inverse mass matrix corresponding to those first 5 particles have been set at zero between the time instant at which the centre of gravity was determined for the last time and the current time instant, then the particles have not moved and it is not necessary to update the centre of gravity.

In another example, if the terms of the adaptive inverse mass matrix corresponding to the first four particles considered have been set at zero between the time instant at which the centre of gravity was determined for the last time and the current time instant, but the terms corresponding to the fifth particle have not been set at zero at a certain time instant (and therefore the 5th particle has moved since the last calculation of the centre of gravity), the centre of gravity is updated incrementally:
multiply g by 5;
subtract from g the previous position of the 5th particle;
add to g the new position of the 5th particle;
divide g by 5.

Use is thus made of the fact that the terms of the adaptive inverse mass matrix corresponding to the first 4 particles were zero.

In another embodiment, the invention proposes a method and a device allowing the calculation of the simulations of a set of objects to be accelerated. The use of the adaptive Hamiltonian makes it possible, during the simulation, to activate or deactivate degrees of freedom, in terms of position, of objects verifying certain criteria. The volume of calculations necessary to update the forces or potential energy relating to those objects can thus be reduced.

In the implementation of a simulation of the behaviour of a set E in an NVT statistical ensemble (set E with a constant number of particles, volume and temperature) considered here by way of illustration, there is used, for example, on the basis of the adaptive Hamiltonian described above, a simulation according to Langevin dynamics (see, for example, “Free energy computations: a mathematical perspective”, T. Lelievre et al., Imperial College Pr, 2010).

The equations of Langevin dynamics are:

dqₜ=∇ₚH_{A}(qₜ,pₜ)dt,

dpₜ=−∇_{q}H_{A}(qₜ,pₜ)dt−γ∇ₚH_{A}(qₜ,pₜ)dt+σdWₜ Formulae (4)

where:
t→dWₜ is a standard 3-dimensional Brownian motion function, and −σ and γ are real 3N*3N matrices that satisfy the following fluctuation-dissipation relation: σσ^{T}=2γ/β, where β=1/k_{B}T, k_{B} being the Boltzmann constant and T being the temperature;
∇ₚH_{A}(qₜ,pₜ) is the gradient of the adaptive Hamiltonian relative to the variable p;
∇ₚH_{A}(qₜ,pₜ) is the gradient of the adaptive Hamiltonian relative to the variable q.

In the case of an NVT simulation, for the integration algorithm, the calculation of a time step can be carried out as follows: half a time step for the Langevin part of the equations, a time step for the Hamiltonian part of the equations, and a further half a time step for the Langevin part of the equations.

There are then obtained the following formulae (5):

$${p}_{n + 1 / 2} = {p}_{n} - ( \frac{\partial {H}_{A} ( {q}_{n} , {p}_{n + 1 / 2} )}{\partial {q}_{n}} + γ \frac{\partial {H}_{A} ( {q}_{n} , {p}_{n + 1 / 2} )}{\partial {p}_{n + 1 / 2}} ) \frac{h}{2} + σ {G}_{n} \sqrt{\frac{h}{2}} , \\ {q}_{n + 1} = {q}_{n} + ( \frac{\partial {H}_{A} ( {q}_{n} , {p}_{n + 1 / 2} )}{\partial {q}_{n + 1 / 2}} ) h , \\ {p}_{n + 1} = {p}_{n + 1 / 2} - ( \frac{\partial {H}_{A} ( {q}_{n + 1} , {p}_{n + 1} )}{\partial {q}_{n + 1}} + γ \frac{\partial {H}_{A} ( {q}_{n + 1} , {p}_{n + 1} )}{\partial {p}_{n + 1}} ) \frac{h}{2} + σ {G}_{n + 1 / 2} \sqrt{\frac{h}{2}} ,$$

where {Gₖ} is a sequence of random Gaussian vectors which are independent and distributed identically with a zero average and a covariance equal to the identity matrix.

One equation of the formulae (5) includes the term pₙ₊₁ in the right- and left-hand terms. In order to solve this implicit equation, a fixed-point algorithm is used, for example.

A program similar to the program P described above is adapted to carry out steps similar to steps 101, 102, 103 by replacing, in those steps, consideration of the equations (3) characteristic of the NVE case by those of the equations (5) characteristic of the NVT case, for the updating of the values of pₙ and qₙ on the basis of the adaptive Hamiltonian H_{A} according to the invention.

Average values can further be calculated during the simulation in an NVT ensemble using the adaptive simulation (that is to say using an adaptive Hamiltonian) according to the invention, so as to determine the values which would have been calculated by carrying out the simulation with a conventional Hamiltonian.

In fact,

$${H}_{A} = \frac{1}{2} {p}^{T} \cdot Φ ( p , q ) \cdot p + V is also written \text{:}$$

$${H}_{A} = \frac{1}{2} {p}^{T} \cdot {M}^{- 1} \cdot p + V ( q ) + \frac{1}{2} {p}^{T} \cdot ( Φ ( p , q ) \cdot p - {M}^{- 1} ) \cdot p$$

that is to say

H_{A}=H+V_{A}(p,q),

where

$${V}_{A} ( p , q ) = \frac{1}{2} {p}^{T} \cdot ( Φ ( p , q ) \cdot p - {M}^{- 1} ) \cdot p$$

and H is the standard (that is to say non-adaptive) Hamiltonian.

If the average value of the variable A obtained with the aid of the parameters p and q obtained with a simulation using a standard Hamiltonian H is denoted [symbol] A [symbol] _{H} and the average value of the variable A obtained with the aid of the parameters p and q obtained with a simulation using an adaptive Hamiltonian H_{A} is denoted [symbol] A [symbol] _{H}_{_{A}}, the value of [symbol] A [symbol] _{H} can be found from the value of [symbol] A [symbol] _{A} by the following equality:

$${〈 A 〉}_{H} = \frac{\int A ( q , p ) {e}^{- \frac{H ( q , p )}{{k}_{B} T}} d q d p}{\int {e}^{- \frac{H ( q , p )}{{k}_{B} T}} d q d p} = \frac{{〈 A {e}^{\frac{{V}_{A}}{{k}_{B} T}} 〉}_{{H}_{A}}}{{〈 {e}^{\frac{{V}_{A}}{{k}_{B} T}} 〉}_{{H}_{A}}}$$

where k_{B}T is the product of the Boltzmann constant k_{B} and the temperature T.

It is possible to show, starting from this equality, that when the variable A depends only on the positions and the adaptive Hamiltonian is separable (that is to say Φ depends only on the moments and not on the positions), then [symbol] A [symbol] _{H}= [symbol] A [symbol] _{H}_{_{A}}.

Therefore, the average values obtained with the aid of an adaptive Hamiltonian are equal to those obtained with the standard Hamiltonian, which is advantageous.

It will be noted that the Euler or Langevin integrators have been considered above for carrying out the invention. It can nevertheless be used with any type of integration algorithm.

In the case considered above, the motion of a particle was fixed in all the dimensions of the displacement space under consideration. In another embodiment, the motion of a particle is fixed on only 1 or some of the axes of displacement, which can be useful for studying certain types of motion.

The number of calculations necessary for updating the components of the forces parallel to that axis or those axes is then reduced.

In the embodiment described above, the position of the particle is fixed when its kinetic energy is below a threshold.

In another embodiment, which may or may not be combined with the preceding embodiments, a particle is fixed during at least one simulation time step, when its moment p assumes certain predetermined values (discrete values, or one or different ranges of values), or even when a couple comprising the moment p and the position q assumes certain fixed values.

In one embodiment, the position of groups of particles is fixed. For example, the value of zero is allocated to the diagonal terms of the adaptive inverse mass matrix relating to a particle aᵢ, of kinetic energy eᵢ, i=1 to 10, only if all the kinetic energy values e₁ to e₁₀ are below a certain threshold. This provision can accelerate the calculations, or allow more accurate calculations, in the calculation of certain potentials.

By way of illustration, four simulations in 2 dimensions of the evolution of an NVE ensemble of N=5930 particles aᵢ, i=1 to N, each with a mass of 1 g/mol, using a Lennard-Jones potential (Eₘ/k_{B}=120 Kelvin, where Eₘ is the energy minimum, equilibrium distance S=3.4 ångströms, cut-off distance 8 ångströms, the potential being truncated smoothly between 7.5 and ångströms) were carried out starting from a shock triggered by sending a particle at high speed into the initially immobile system: a reference simulation based on a standard Hamiltonian, and three adaptive simulations, that is to say using an adaptive Hamiltonian of a method according to the invention as described above (time step of size 0.0488 femtoseconds (fs), 7000 time steps, total simulation time 342 fs).

For each of the simulations using an adaptive Hamiltonian, the square root of the fluctuation relative to the standard simulation, denoted RMSD, is given, as is the maximum particle displacement error Δqₘₐₓ.

$$R M S D = \sqrt{\frac{{\sum }_{i = 1}^{N} {‖ {q}_{i} - {q}_{i}^{f} ‖}^{2}}{N}} ,$$

where q is the vector of the coordinates of the particle aᵢ at the last step of the adaptive simulation and qᵢ^{f} is the vector of the coordinates of that same particle at the last step of the reference simulation.

For example, for the adaptive simulation where εᵢ^{r}=0 and εᵢ^{f}=0.01 kcal/mol (i=1 to N), an acceleration factor of the calculation time necessary for carrying out this adaptive simulation relative to the calculation time relating to the reference simulation having a value equal to 2.5 is obtained, RMSD=0.0114 S and Δqₘₐₓ=0.18 S, wherein S is the equilibrium distance in the Lennard-Jones potential used.

For the adaptive simulation where εᵢ^{r}=0.05 and εᵢ^{f}=0.1 (i=1 to N), an acceleration factor of the calculation time necessary for carrying out this adaptive simulation relative to the calculation time relating to the reference simulation having a value equal to 5 is obtained, and RMSD=0.0612 S and Δqₘₐₓ=0.3 S.

For the adaptive simulation where εᵢ^{r}=0.625 and εᵢ^{f}(i=0.7 (i=1 to N), an acceleration factor of the calculation time necessary for carrying out this adaptive simulation relative to the calculation time relating to the reference simulation having a value equal to 10 is obtained, and RMSD=0.359 S and Δqₘₐₓ=13.94 S.

Appreciable gains are also found by carrying out the invention relative to NVT particle ensembles. Thus, a method according to the invention allows the calculations to be accelerated considerably, with a small alteration in the behaviour.

1. Method for simulating a system of elements, according to which the behaviour of said elements is determined on the basis of a Hamiltonian H of the system of elements, such that
$$H ( p , q ) = \frac{1}{2} {p}^{T} \cdot {M}^{- 1} \cdot p + V ,$$
where p is a vector indicating the moments of the elements, q is a vector indicating the positions of the elements, M⁻¹ being a diagonal matrix that is a function of the masses of the elements, and V being the potential energy of the system, said method being carried out by a computer and being characterized in that said method comprises a step according to which, when the moment vector p assumes certain predetermined values relating to at least one element, a value of zero is allocated to at least one diagonal term of the matrix M⁻¹ relating to said element.

2. Method for simulating a system of elements according to claim 1, according to which said method comprises a step according to which, for at least one of said elements, if a parameter representing the kinetic energy of said element has a value below a first strictly positive threshold, a value of zero is allocated to at least one diagonal term of the matrix M⁻¹ relating to said element.

3. Method for simulating a system of elements according to claim 1, according to which the diagonal terms of the matrix M⁻¹ which are a function of the mass of an element are allocated a maximum value when the kinetic energy of said element is greater than a second strictly positive threshold.

4. Method for simulating a system of elements according to claim 1, according to which a value of zero is allocated to at least one diagonal term of the matrix M⁻¹ relating to said element if the couple comprising the moment of the element and the position of the element assumes certain predetermined values.

5. Method for simulating a system of elements according to claim 1, comprising a step of determining values of at least one piece of information at successive simulation time instants on the basis of said Hamiltonian, said step utilizing the fact that the values of the information relating to a k-uplet of elements, where k is an integer greater than or equal to 2, for which a value of zero has been allocated to the diagonal terms of the matrix M⁻¹ at a preceding simulation time instant are consequently unchanged between at least said preceding simulation time instant and the current simulation time instant, and calculating a value of the information relating to a given element at a current simulation time instant by carrying out the following steps when values of zero have not been allocated to the diagonal terms of the matrix concerning each element of a k-uplet of elements of which said given element forms part:
calculate a working value of said information relating to said given element by subtracting from the value of the information relating to said given element and determined at the preceding simulation time instant at least the values of the information relating to said given element and associated with said k-uplets of elements at the preceding simulation time instant, and/or
add to said working value at least the values of the information relating to said given element and associated with the k-uplets of elements, determined at the current simulation time instant.

6. Method for simulating a system of elements according to claim 1, according to which, at a current calculation time instant, a current list of the pairs of elements that are separated by a distance below a given threshold is prepared at a current simulation time instant and is compared with a preceding list of pairs of elements that are separated by a distance below a given threshold prepared at a preceding simulation time instant, and according to which the value of a piece of information relating to a given element, at a current simulation time instant, is calculated on the basis of the pairs comprising said given element by carrying out the following steps:
calculate a working value by subtracting from the value of information relating to said given element and determined at the preceding simulation time instant the values of information relating to said given element associated with the other element of the pairs under consideration if the pair under consideration is present only in the preceding list or if the vector linking said given element to the other element of the pair has varied between the preceding simulation time instant and the current simulation time instant;
the value of the information relating to said given element at a current simulation time instant is determined by adding to the working value the values of the information relating to said given element and associated with the other element of the pairs under consideration if the pair under consideration is present only in the current list or if the vector linking said element to the other element of the pair has varied between the preceding simulation time instant and the current simulation time instant.

7. Method for simulating a system of elements according to claim 1, according to which, at a current calculation time instant, a current list of k-uplets of elements that satisfy certain conditions, where k is an integer greater than or equal to two, is prepared at a current simulation time instant and is compared with a preceding list of k-uplets of elements that satisfy said conditions at a preceding simulation time instant,
and according to which the value of a piece of information relating to an element at a current simulation time instant is calculated on the basis of the k-uplets comprising said element by carrying out the following steps:
calculate a temporary value by subtracting from the value of the information relating to said element and determined at the preceding simulation time instant the values of the information relating to said element and associated with said k-uplets at the preceding simulation time instant, when said k-uplets are present only in the preceding list or when the values of the information relating to said element and associated with said k-uplets have changed between the preceding simulation time instant and the current simulation time instant;
determine the value of the information relating to said element at the current simulation time instant by adding to the temporary value the values of the information relating to said element and associated with said k-uplets at the current simulation time, when said k-uplets are present only in the current list or when the information associated with said k-uplets has changed between the preceding simulation time instant and the current simulation time instant.

8. Method for simulating a system of elements according to claim 1, according to which the localization space of the elements is partitioned into cells and each element, at each preceding simulation time instant and a current simulation time instant, is associated with a belonging cell according to position coordinates determined at said simulation time instant, and according to which, for the first elements such that the terms of the matrix M⁻¹ relating to said first elements have not been allocated a value of zero at a current simulation time instant, the following steps are carried out:
the belonging cell of the first elements at the preceding simulation time instant is determined;
for each first element, there are determined in said belonging cell or its cells in a given vicinity of the belonging cell, the second elements that are situated at the preceding simulation time instant at a distance below a given threshold from said first element; a working value is calculated by subtracting from the value of a piece of information relating to said first element and determined at the preceding simulation time instant the values of said information relating to said first element and associated with said second elements;
the new belonging cell of the first elements at the current simulation time instant is determined;
for each first element, there are determined in the new belonging cell or the cells in the given vicinity of the new belonging cell, the third elements that are situated at the current simulation time instant at a distance below a given threshold from said first element;
the value of the information relating to said first element, at the current simulation time instant, is determined by adding to the working value the values of the information relating to the first element and associated with the third elements.

9. Method for simulating a system of elements according to claim 1, according to which the information relating to said element includes the potential energy of said element and/or the interaction force applied to said element.

10. Method for simulating a system of elements according to claim 1, comprising, at certain simulation time instants, a step of determining a piece of information I, said step advantageously utilizing the fact that a value of zero has been allocated to certain diagonal terms of the matrix M⁻¹ at certain simulation time instants.

11. Method for simulating a system of elements according to claim 1, comprising, at certain simulation time instants, a step of determining a piece of information I, said step advantageously utilizing the fact that the piece of information I is unchanged and does not have to be determined again when it has been determined at a previous simulation time instant and a value of zero has been allocated to a corresponding set of diagonal terms of the matrix M⁻¹ between at least said previous simulation time instant and the current simulation time instant.

12. Method for simulating a system of elements according to claim 1, comprising, at certain simulation time instants, a step of determining the potential energy, or the interaction forces, said step advantageously utilizing the fact that a value of zero has been allocated to at least one diagonal element of the matrix M⁻¹ at certain simulation time instants.

13. Computer program for simulating a system of elements, comprising software instructions for carrying out the steps of a method according to claim 1 during execution of the program by computing means.
